(19) United States
(12) Patent Application Publication
(10) Pub. No.: US 2018/0018654 A1
(43) Pub. Date: Jan. 18, 2018

(54) PORTABLE ELECTRONIC PAYMENT SECURITY DEVICES, SYSTEMS AND METHODS

(71) Applicant: Mike Miskin, Sleepy Hollow, IL (US)

(72) Inventor: Mike Miskin, Sleepy Hollow, IL (US)

(21) Appl. No.: 15/651,499

(22) Filed: Jul. 17, 2017

Related U.S. Application Data
(60) Provisional application No. 62/493,781, filed on Jul. 15, 2016.

(51) Int. Cl. G06Q 20/32; G06Q 20/40; G08B 21/18; G06Q 20/34; H04W 84/12; H04W 4/00

(52) U.S. Cl. CPC G06Q 20/322; G08B 21/182; G06Q 20/34; H04B 1/3827; G06Q 20/3278; G06Q 20/4014; H04W 4/008; H04W 84/12

(57) ABSTRACT

A electronic payment security system having at least two portable electronic devices in predetermined 2-way electronic communication or connectivity with each other with an electronic payment method authentication technology integrated into at least one of the two portable electronic devices. The at least one portable electronic device having the integrated payment method authentication technology transmitting a response request to any portable electronic devices in predetermined 2-way electronic communication with the at least one portable electronic device when the integrated payment method is activated on the at least one portable electronic device at a merchant payment terminal. The at least one portable electronic device prevents use of the integrated payment method if no response is received from any portable electronic devices in predetermined 2-way electronic communication with the at least one portable electronic device.

### RELATED APPLICATIONS

The present application claims priority to U.S. App. Ser. No. 62/493,781 filed Jul. 15, 2016, the contents of which are fully incorporated herein by reference.

### TECHNICAL FIELD

The present invention generally relates to electronic payment security devices, methods and systems, and more specifically relates to an electronic payment security system using 2-Way communication between portable devices, at least one of which is enabled to make electronic payments.

### FEDERALLY SPONSORED RESEARCH OR DEVELOPMENT

None.

### BACKGROUND OF THE INVENTION

Portable electronic devices and mobile electronic devices have rapidly evolved over the past several years. Portable electronic devices are available in many forms for many uses including but not limited to portable phones and smart phones, laptop and tablet computers, wearable technologies and more. Mobile phone devices have advanced significantly since the release of the first cell phone technology. What was initially released as a portable phone that could be taken out of the home into the car just to make a phone call, has turned into smart phones which are handheld computers having more processing power, capability and features than early personal computers had. Many portable electronic devices can be miniaturized to a very small size while still comprising substantial intelligence, memory, processing capability, audio output, sensors, a power source and more. Many unique portable electronic devices can be made small enough to be a key chain or connected to a key chain, purse or put into a pocket, and can have integrated information, sensing capability, tracking capability, transmitter and/or receiver technology using, for example, radio-frequency identification (“RFID”), Bluetooth®, WiFi, near field Communication, data storage and more.

“Wearable electronic devices” are also now rapidly becoming more popular. Wearable electronic technology devices are embodied many forms including wearable communication devices, wearable health monitoring/tracking devices, wearable sports and fitness devices, watches, and more generally devices designed to mount to a wrist but could be designed to mount on other areas of the body or items typically carried with an individual, like for example a key-chain, belt, belt loop, purse strap or the like. Wearable technology devices may also include any and/or all of the features previously described above integrated within mobile phones and portable electronic devices.

Portable electronic devices, including wearable electronic devices, can now be used for facilitating payments, both over the Internet, over wireless networks and at point of sale locations. Payment may be made by the portable and/or wearable electronic devices rather than using a physical payment method like cash, checks or credit cards, and each portable electronic device may be outfitted with multiple payment platforms eliminating the need to carry, for example, multiple physical credit cards.

While payments with portable and/or wearable electronic devices are becoming more popular, security threats and concerns still exist. For example, when used as a payment means, portable electronic devices typically use near field communications (“NFC”) technology which is a form of RFID technology that requires the electronic device to be in close proximity to, or touching a merchants NFC enabled payment terminal to complete a transaction with a consumer using the portable electronic device. Other elements of security may be utilized as well, like for example, finger print identification.

Additionally, credit card security continues to be a problem for consumers and merchants regardless of the latest technology. Credit card security chips exist today and the banks and/or credit card companies are increasingly implementing credit card security chips within their cards. The new international standard for credit card security is called “Chip and PIN.” With Chip and PIN cards, the credit card data is stored on a chip in the credit card—not a magnetic stripe—and customers punch in a four-digit PIN (personal identification number) instead of signing the screen.

In addition to RFID information potentially being stolen, or merchant systems being hacked, credit cards and portable electronic devices can be lost and/or stolen, resulting in billions of dollars of fraudulent financial transactions annually, hurting consumer's credit and security.

As such, it would be advantageous to increase transaction security by insuring that an account owner is at the location the transaction is occurring, reducing potential fraud and fraudulent transactions resulting from lost or stolen payment devices or cards.

### SUMMARY OF THE INVENTION

Accordingly, the present invention is directed to providing enhanced security and user identification when any form of portable electronic device, which include portable phones or smart phones, wearable technology or wearable electronic devices, and other portable electronic devices are used. Any payment device using electronics including a credit card, including those having Chip and Pin, and any device transferring personal payment information via wireless connectivity using antenna, light communication, NFC and/or MID technology though payment tags, or any portable electronic device providing payment authorization methods such as a smart phone with pay-by-phone or portable payment technology, may be secured. Any stored payment authorization information or payment software, apps or other means which may be used to facilitate payment using a portable electronic device, hereinafter referred to as “electronic payment method” or “EPM” or “integrated payment method,” may be secured under the present invention.

For the purposes of the invention, a merchant payment terminal is any device, terminal, computer, software and/or algorithm used to receive electronic payments, confirmation, authorization and/or authentication by a merchant.

According to one aspect of the invention, an electronic payment security system is provided. The system includes at least two portable electronic devices which are placed in predetermined 2-way electronic communication or connectivity with each other. An electronic payment method authentication technology is integrated into at least one of the two portable electronic devices, as an application (“app”) or the like. The at least one portable electronic device having the integrated payment method authentication technology transmits a response request to any portable electronic devices in predetermined 2-way electronic communication with the at least one portable electronic device when the integrated payment method is activated on the at least one portable electronic device at a merchant payment terminal. The at least one portable electronic device will prevent use of the integrated payment method if no response is received from any portable electronic devices in predetermined 2-way electronic communication with the at least one portable electronic device.

According to another aspect of the invention, the at least two portable electronic devices may sense and respond to the distance between each other. Any portable electronic devices responding to a request for a response from the at least one portable electronic device must be within a predetermined distance from the at least one electronic device to provide the response. If the responding device is outside the predetermined distance, no response will be sent causing the at least one portable electronic device to prevent use of the integrated payment method. If the distance is sensed while the integrated payment method is not in use, the at least one electronic device may at least temporarily disable the integrated payment method if any portable electronic devices in predetermined 2-way electronic communication with the at least one portable electronic device are outside a predetermined range. If any portable electronic devices are outside the predetermined range, at least one of the two portable electronic devices may produce an alert that the at least two portable electronic devices have exceeded a predetermined range from each other. The alert may be one or more of an audio alert, a visual alert, or a vibratory alert produced by one of the portable electronic devices. In addition or in the alternative to any alert to the user, an alert may be provided to the integrated payment method facilitator to place a temporary or permanent hold on the integrated payment method and any accounts associated therewith.

According to another aspect of the invention, at least one of the two portable electronic devices may include but are not limited to, a portable phone, a smart phone, a wearable electronic device or a credit card. Regardless of the type of electronic devices, the 2-way electronic communication between the at least two portable electronic devices may be accomplished using one or more of Bluetooth® communication, Wi-Fi, light communication, RIFD or near field communication. Likewise, communication between the least one portable electronic device and the merchant payment terminal to activate the integrated payment method may include any of Bluetooth® communication, Wi-Fi, light communication, RFID or near field communication, magnetic swipe or magnetic coupling.

According to another aspect of the invention, the required response from any portable electronic devices in predetermined 2-way electronic communication with the at least one portable electronic device may be temporarily disabled.

According to one aspect of the invention, an electronic payment security system is provided. The system utilizes at least two portable electronic devices in one or more of short range 2-way electronic connectivity or communication with each other. At least one of the at least two portable electronic devices are able to sense, and if necessary respond to, the distance between each of the electronic devices in 2-way communication with the at least one portable electronic device. An electronic payment method is integrated into the at least one portable electronic device able to sense the distance between the portable electronic devices, and the at least one portable electronic device is capable of connecting to or communicating with a merchant payment terminal to facilitate a payment. The electronic payment method may be at least temporarily disabled from making a financial transaction when the at least two portable electronic devices are sensed as being outside a predetermined range from each other.

At least one of the two portable electronic devices may include but are not limited to, a portable phone, a smart phone, a wearable electronic device, or a credit card. Regardless of the type of electronic devices, the 2-way electronic communication between the at least two portable electronic devices may be accomplished using one or more of Bluetooth® communication, Wi-Fi, light communication, RFID or near field communication. Likewise, communication between the least one portable electronic device and the merchant payment terminal to activate the integrated payment method may include any of Bluetooth® communication, Wi-Fi, light communication, RFID or near field communication, magnetic swipe or magnetic coupling.

According to one aspect of the invention, 2-Way portable electronic security devices are provided in the form of at least two portable electronic devices in predetermined 2-way electronic communication or connectivity with each other. An electronic payment method authentication technology is integrated into at least one of the two portable electronic devices. The at least one of the at least two portable electronic devices having the integrated payment method authentication technology may transmit a response request to any portable electronic devices in predetermined 2-way electronic communication with the at least one portable electronic device when the integrated payment method is activated on the at least one portable electronic device at a merchant payment terminal. The at least one portable electronic device may then prevent use of the integrated payment method if no response is received from any portable electronic devices in predetermined 2-way electronic communication with the at least one portable electronic device. Any portable electronic devices responding to a request for a response from the at least one portable electronic device may be required to be within a predetermined distance from the at least one electronic device to provide the response.

According to another aspect of the invention, the at least two portable electronic devices may sense and respond to the distance between each other. Any portable electronic devices responding to a request for a response from the at least one portable electronic device must be within a predetermined distance from the at least one electronic device to provide the response. If the responding device is outside the predetermined distance, no response will be sent causing the at least one portable electronic device to prevent use of the integrated payment method. If the distance is sensed while the integrated payment method is not in use, the at least one electronic device may at least temporarily disable the integrated payment method if any portable electronic devices in predetermined 2-way electronic communication with the at least one portable electronic device are outside a predetermined range. If any portable electronic devices are outside the predetermined range, at least one of the two portable electronic devices may produce an alert that the at least two portable electronic devices have exceeded a predetermined range from each other. The alert may be one or more of an audio alert, a visual alert, or a vibratory alert produced by one of the portable electronic devices. In addition or in the alternative to any alert to the user, an alert may be provided to the integrated payment method facilitator to place a temporary or permanent hold on the integrated payment method and any accounts associated therewith.

According to another aspect of the invention, at least one of the two portable electronic devices may be any of a portable phone, a smart phone, a wearable electronic device or a credit card. Regardless of the type of electronic devices, the 2-way electronic communication between the at least two portable electronic devices may be accomplished using one or more of Bluetooth® communication, Wi-Fi, light communication, RFID or near field communication. Likewise, communication between the least one portable electronic device and the merchant payment terminal to activate the integrated payment method may include any of Bluetooth® communication, Wi-Fi, light communication, RFID or near field communication, magnetic swipe or magnetic coupling.

According to one aspect of the invention, the required response from any portable electronic devices in predetermined 2-way electronic communication with the at least one portable electronic device may be temporarily disabled.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 shows a schematic view of an embodiment of the invention;

FIG. 2 shows a schematic view of an embodiment of the invention;

FIG. 3 shows a schematic view of an embodiment of the invention;

FIG. 4 shows a schematic view of an embodiment of the invention;

FIG. 5 shows a flow chart of a method carried out by an embodiment of the invention;

FIG. 6 shows a flow chart of a method carried out by an embodiment of the invention; and

FIG. 7 shows a flow chart of a method carried out by an embodiment of the invention.

### DETAILED DESCRIPTION OF PREFERRED EMBODIMENTS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

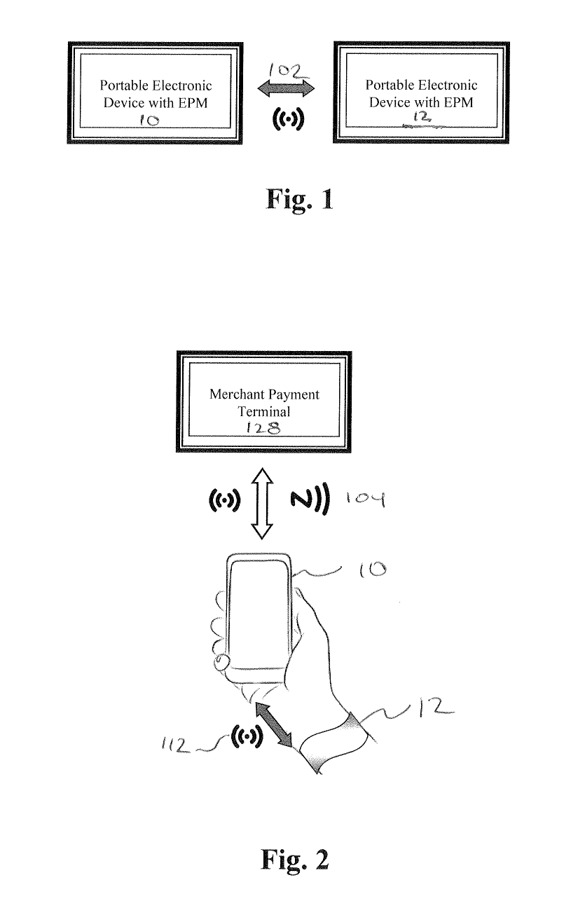

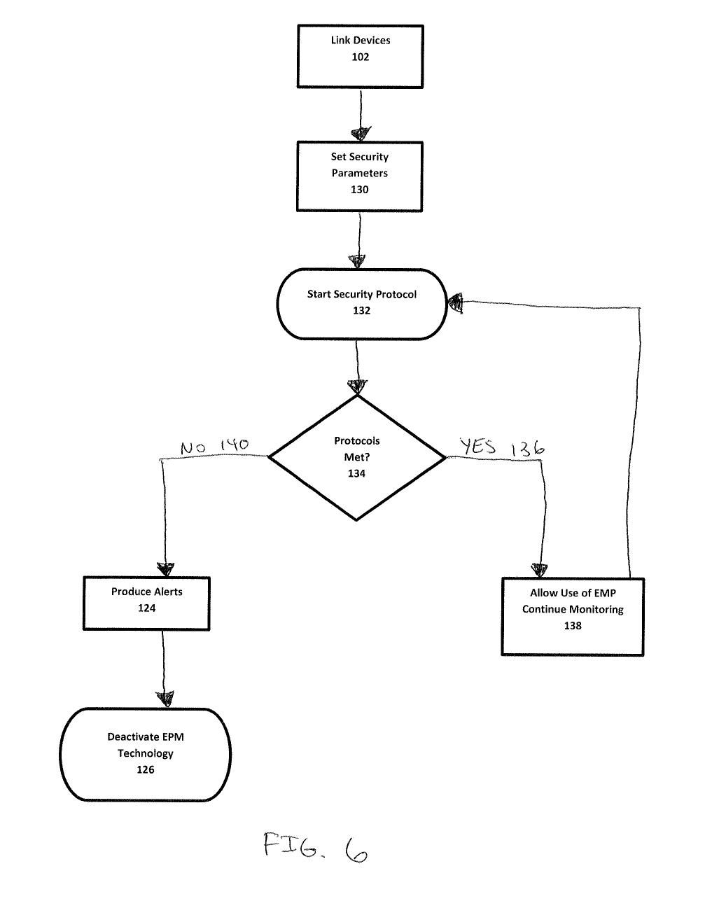

As seen in FIGS. 1 and 5, for example, a first portable electronic device 10 can be placed in 2-way communication or connected (linked, 102) with a second portable electronic device 12. An electronic payment method technology (“EPM”) may be pre-installed or installed after linking on one or both of the portable electronic devices (100). Though the specification may discuss the devices, systems and methods herein in terms of two portable electronic devices for the sake of simplicity, it should be understood that any number of portable electronic devices may be linked, connected and/or placed in communication in order to enhance the security of the devices and system. Where multiple devices are placed in communication, like for example three or more, any number of the portable electronic devices may have an EPM technology to facilitate transactions stored installed thereon. Where three devices are used or incorporated into the system and/or method, for example, one, two or three of the devices may have the electronic payment method technology installed on the device. When utilizing the EPM technology installed on any devices which are linked together to complete or facilitate a transaction, like for example when using the an EPM technology installed on a first portable electronic device, the requirements of the first and second device as discussed herein may apply equally to any and all subsequent devices which are linked or placed in communication with or connected to the first device depending upon parameters set within the portable electronic devices. When a third portable electronic device is linked, for example, it should be understood that the requirements between the first and second device for the transaction to proceed may be repeated or completed simultaneously with the third device in substantially the same manner as the second device in order to insure maximum security.

The at least two linked portable electronic devices 10, 12 may be linked to each other using short range 2-way electronic connectivity and/or in communication using any known linking or communication method. For example, devices 10, 12 may be linked using Bluetooth®, WiFi, light communication, RFID or near field communication (“NFC”).

Once devices 10, 12 are linked, and the EPM installed on one of the devices 10, 12 is activated (104) at a merchant payment terminal 128 to complete a transaction, the device on which the EPM is activated, device 10, will make a determination if the device has an active security protocol/parameters which the device is required to follow with respect to a second portable electronic device, device 12 (106). If the security link is deactivated on device 10 (108), device 10 will complete the transaction to proceed as requested (110).

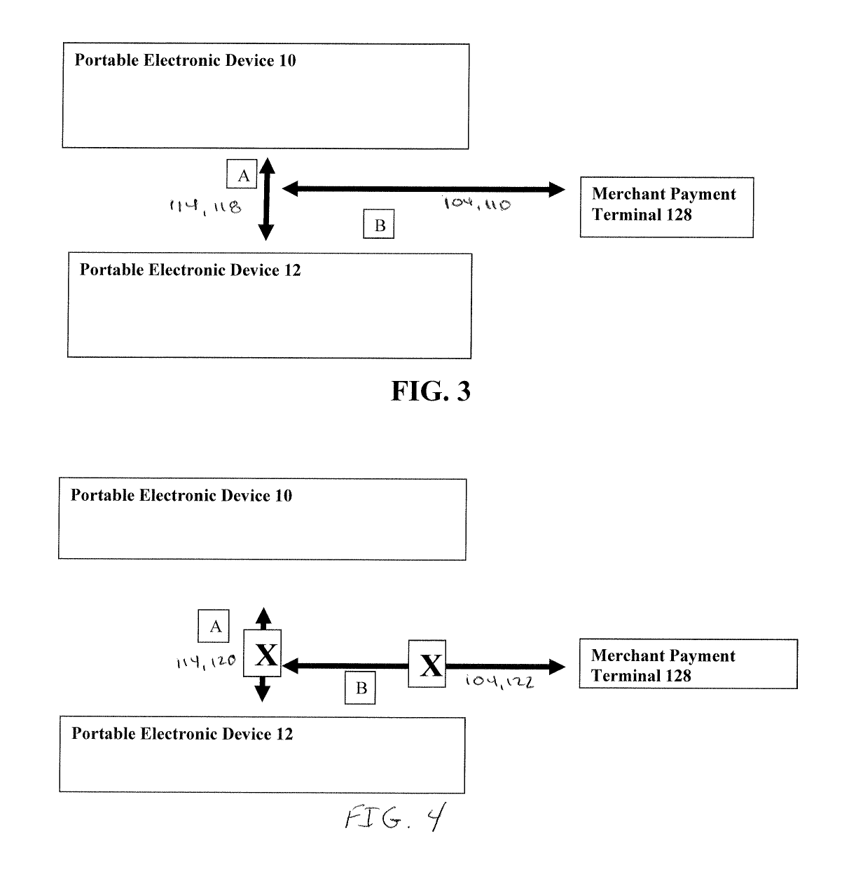

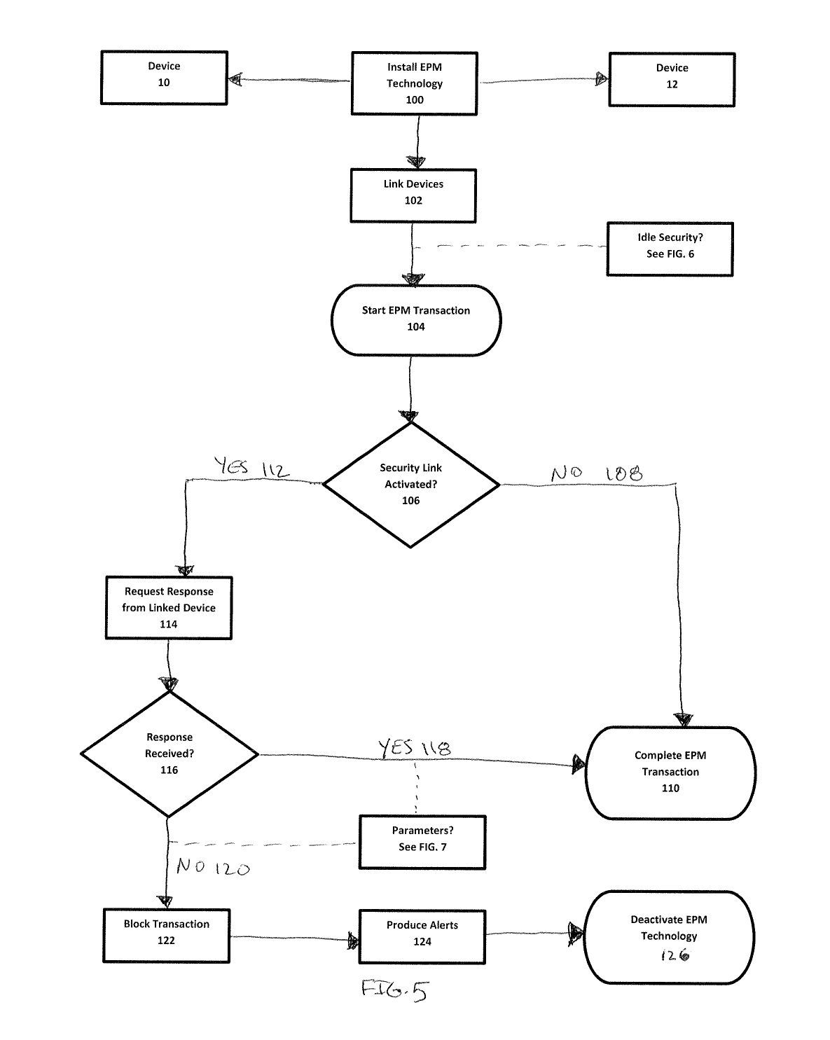

As seen in FIGS. 2-5, if device 10 requires communication with device 12 to allow the requested transaction to proceed (112), device 10 will request a response from device (112) using the 2-way communication or connectivity or link established between devices 10 and 12 (116). If a response is received from linked device 12 (118) as shown in FIGS. 3 and 5, device 10 will complete the transaction as requested (110).

If device 10 does not receive a response from linked device 12 (120), as seen in FIGS. 4 and 5, device 10 will block the requested transaction (122), produce and transmit any set alerts (124) and deactivate the EMP (126) on the device, device 10. Devices 10 and 12 must be in linked communication at the time of use of the EMP in order for device 10 to allow the transaction to be completed as requested if the devices are linked and the security protocols are active.

Various alerts may be set in device 10 and/or device 12 in order to notify a user and/or financial services provider or account manager for an installed EPM if device 10 denies a transaction as a result of a failure to receive a response from device 12. Device 10 and/or device 12 may be set to provide alerts to a user in the form of one or more of an auditory alert, a visual alert, a vibratory alert or an electronic communication like for example an email, a text message or an automated phone call.

Device 10 and/or device 12 may be set to provide an alert to a financial services provider or account manager for the installed EPM to notify of a broken link. Such an alert may be in the form of an electronic communication like for example an email, a text message or an automated phone call, and/or may be an automated notice to place an account hold on the EPM and any affiliated accounts to prevent usage of the EPM and any linked funds, credit cards and bank accounts.

In addition to alert settings, when installing the security protocols and parameters, and linking devices 10, 12, additional security parameters may be set in order to prevent theft of an EPM enabled device and/or insure more efficient notification of any theft/loss of an EPM enabled device (or linked device for that matter).

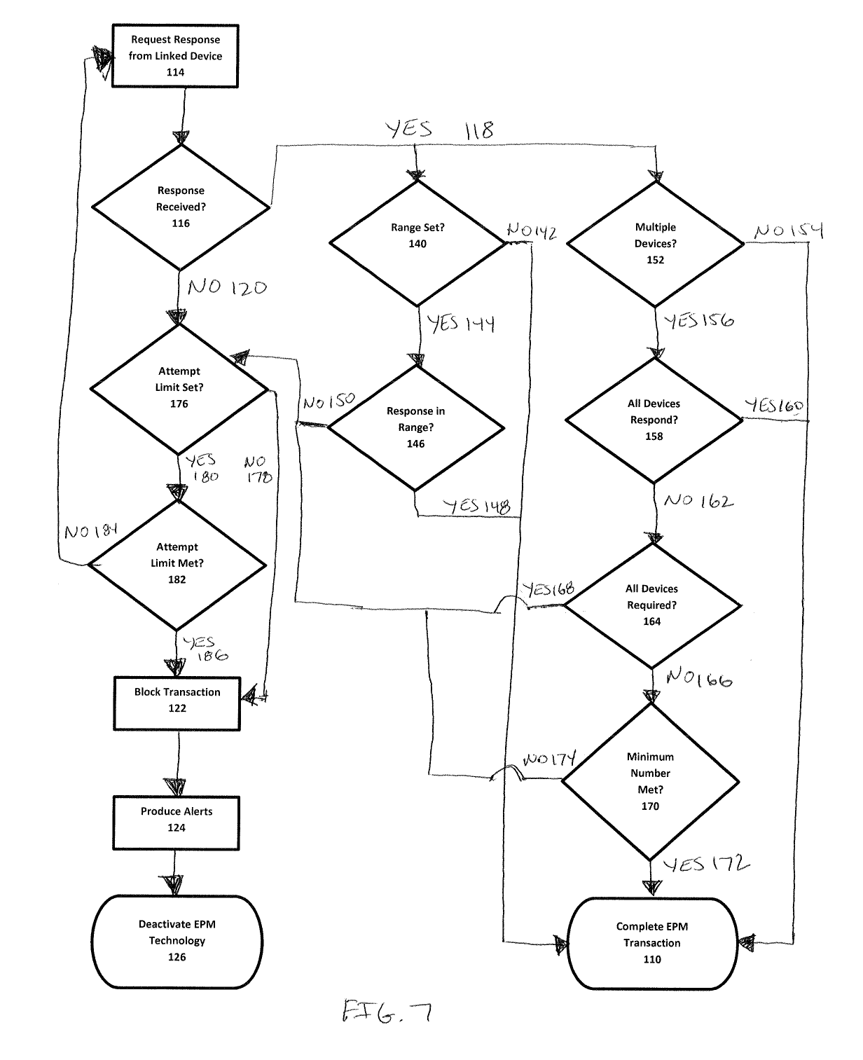

For example, as seen in FIG. 6, when devices 10, 12 are linked (102) or any time thereafter, connectivity parameters may alternatively be set (130) in order to periodically insure devices 10, 12 are both within proximity of each other. Connectivity parameters/protocols which may be set include, for example, periodic pinging or communication between device 10 and device 12 to insure the devices are still proximately located each other. Device 10 may within some period set by a user periodically transmit a request for response from device 12. If a response from device 12 (134) is received (136), device 10 will allow for free use of the installed EMP (138) and continue to periodically monitor the link with device 12. If a response (134) is not received (140) from device 12, device 10 and/or device 12 may proceed in producing and transmitting any set alerts (124) and deactivating the installed EMP (126) to prevent any future use until the connection with device 12 is either re-established, the security protocols are deactivated and/or the security link is reset.

In addition to pinging and/or requesting a response from device 12, parameters which may be set within device 10 include, but are not limited to a distance device 12 is located from device 10 and the amount of time within which a response must be received from device 10. Distance may be determined by controlling the signal strength of the request from device 10 and/or 12 when pinging the opposing device, may be done through internal means like GPS or tracking software, or may be done through pinging any local WiFi or other networks and triangulating the position of each element based upon known or calculated locations.

It should be understood for maximum security and protection, parameters requiring periodic communication between both devices 10, 12 may be set in order to insure both devices remain proximate to each other. Both device 10 and device 12 may be set to require communication from the other periodically to insure that both devices remain within proximate range of each other.

Rather than immediately deactivating the EMP and producing and transmitting any alerts, parameters may be set regarding the number of failed attempts to ping or receive a response from device 10 and/or device 12 must be reached before device 10 and/or device 12 produces and transmits any alerts and deactivates the EMP. A general parameter may be set, for example, that until after some set number failed attempts to receive a response from device 12 and/or device 10, the EMP will remain active unless the failed response is the result of an attempted use of the EMP on the device.

Separate sets of parameters may also be set based on location or usage parameters. If the EMP on device 10 was recently used, rather than follow a general setting if no response is received from device 12 in response to a periodic ping, parameters may be set to immediately ping device 12 again, with device 10 immediately deactivating the EMP and producing and providing any set alerts if the second periodic ping is not responded to.

When both devices 10, 12 have EMP technology installed and enabled thereon, it should be understood that both devices may have the same or different parameters set for periodically requiring a response from each other. In such cases, a device 10, which may be a smart phone, for example, may have one set of parameters to ping device 12, which may be a wearable electronic device worn by the user for example, while device 12 has the same or different parameters for pinging device 10.

Rather than requiring a simple response from device 12 when the EMP technology on device 10 is activated at a merchant payment terminal 128, as seen in FIG. 7, further parameters may be set in order to provide further device security.

When a request (116) is responded to by device 12 (118), parameters may be set which require device 12 to be located within a set range or distance (140) from device 10. If no range is set (142), or if device 12 is sensed and located within range of device 10 when responding (148), the transaction will be allowed to proceed as requested (110). If the response from device 12 is determined to be outside the distance range set in the device parameters (150), device 10 will proceed as though “NO” response (120) we received from device 12.

A parameter may also be set for when additional portable electronic devices are linked to device 10 (152). If only one device is currently linked to device 10 (154), device 10 will proceed with the transaction as requested (110) if a response is received from device 12 (118). If multiple portable electronic devices are linked to device 10 (156), if each linked portable electronic device responds (158) to a request from device 10 (168), device 10 will proceed with the transaction as requested (110).

If less than all of the linked devices respond (162), parameters may be set for how device 10 reacts to allow or block the transaction. Device 10 may be set to require all linked portable electronic devices (164) to respond. If device 10 is set in this manner, then device 10 will proceed (168) as through “NO” response (120) we received from device 12 if a response is not received from each linked portable electronic device.

If device 10 is set to allow the transaction to proceed with a response from fewer than all linked portable electronic devices (166), device 10 will determine whether the minimum number of portable electronic devices which are required to respond to a request was met (170). If the at least the minimum number of portable electronic devices have responded to the request (172), device 10 will complete the transaction as requested (110). If the minimum required number of portable electronic devices have not responded to the request (174), device 10 may proceed as if “NO” response (120) we received from device 12.

Whether one or multiple portable electronic devices are linked to device 10, parameters may be set by device 10 which require additional attempts to ping or receive a response from device 12 or any other linked devices if no response is initially received (176) from one or more linked devices. If a set maximum number of attempts to receive a response is set (176) and has not been reached (182) without a response being received, device 10 may continue to request a response (184) from device 12 or any other linked device before proceeding as though “NO” response was received from device 12. If the maximum number of attempts has been reached (186), device 10 will proceed as if “NO” response was received from device 12 and block the transaction (122), produce and provide any alerts (124) and deactivate the EPM technology (126) on device 10.

Any of the settings/parameters/protocols discussed herein, including any required link between devices 10, 12, may be disabled by a user. Security parameters and protocols may be set within device 10 which allow for some or all of the parameters and requirements for the link between devices 10, 12 for the EPM to operate may be disabled. Password protection, two step authentication, fingerprint authentication or any combination thereof, for example, may be required in order for the link or any set parameter to be disabled in device 10 and/or 12.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. An electronic payment security system comprising:
a. at least two portable electronic devices in predetermined 2-way electronic communication or connectivity with each other;
b. an electronic payment method authentication technology integrated into at least one of the two portable electronic devices;
c. the at least one portable electronic device having the integrated payment method authentication technology transmitting a response request to any portable electronic devices in predetermined 2-way electronic communication with the at least one portable electronic device when the integrated payment method is activated on the at least one portable electronic device at a merchant payment terminal; and
d. the at least one portable electronic device preventing use of the integrated payment method if no response is received from any portable electronic devices in predetermined 2-way electronic communication with the at least one portable electronic device.

2. The system of claim 1, wherein any portable electronic devices responding to a request for a response from the at least one portable electronic device must be within a predetermined distance from the at least one electronic device to provide the response.

3. The system of claim 1, wherein at least one of the two portable electronic devices is a portable phone.

4. The system of claim 1, wherein at least one of the two portable electronic devices is a smart phone.

5. The system of claim 1, wherein at least one of the two portable electronic devices is a wearable electronic device.

6. The system of claim 1, wherein at least one of the two portable electronic devices is a credit card.

7. The system of claim 1, wherein 2-way electronic communication between the at least two portable electronic devices comprises one or more of Bluetooth® communication, Wi-Fi, light communication or near field communication.

8. The system of claim 1, wherein communication method between the least one portable electronic device and the merchant payment terminal to activate the integrated payment method comprises one or more of Bluetooth® communication, Wi-Fi, light communication or near field communication, magnetic swipe or magnetic coupling.

9. The system of claim 1, wherein the at least two portable electronic devices sense and respond to the distance between each other.

10. The system of claim 9, wherein the at least one electronic device may at least temporarily disable the integrated payment method if any portable electronic devices in predetermined 2-way electronic communication with the at least one portable electronic device are outside a predetermined range.

11. The system of claim 9, wherein at least one of the two portable electronic devices produces any alert that the at least two portable electronic devices have exceeded a predetermined range from each other.

12. The system of claim 11, wherein the alert is one or more of an audio alert, a visual alert, or a vibratory alert.

13. The system of claim 11, wherein the alert is provided to the integrated payment method facilitator to place a temporary or permanent hold on the integrated payment method and any accounts associated therewith.

14. The system of claim 1, wherein the required response from any portable electronic devices in predetermined 2-way electronic communication with the at least one portable electronic device may be temporarily disabled.

15. The system of claim 1, wherein a software application is embedded into at least one of the at least two portable electronic devices.

16. The 2-Way Portable Electronic Security Devices of claim 1 in wireless communication with each other.

17. At least one of the 2-Way Portable Electronic Security Devices of claim 1 being capable of wirelessly communicating with a merchant payment terminal.

18. A electronic payment security system comprising:
a. at least two portable electronic devices in one or more of short range 2-way electronic connectivity or communication with each other;
b. at least one of the at least two portable electronic devices being able to sense the distance between each of the electronic devices in 2-way electronic connectivity or communication with each other;
c. an electronic payment method integrated into the at least one of the at least two portable electronic devices able to sense and respond to the distance between each of the electronic devices;
d. the at least one of the at least two portable electronic devices being capable of connecting or communicating with a merchant payment terminal; and
e. the electronic payment method being at least temporarily disabled from making a financial transaction when the at least two portable electronic devices are outside a predetermined range from each other.

19. The system of claim 1, wherein at least one of the two portable electronic devices is a portable phone.

20. The system of claim 1, wherein at least one of the two portable electronic devices is a smart phone.

21. The system of claim 1, wherein at least one of the two portable electronic devices is a wearable electronic device.

22. The system of claim 1, wherein at least one of the two portable electronic devices is a credit card.

23. The system of claim 1, wherein 2-way electronic communication between the at least two portable electronic devices comprises one or more of Bluetooth® communication, Wi-Fi, light communication or near field communication.

24. The system of claim 1, wherein communication method between the least one portable electronic device and the merchant payment terminal to activate the integrated payment method comprises one or more of Bluetooth® communication, Wi-Fi, light communication or near field communication, magnetic swipe or magnetic coupling.

25. The at least two Portable Electronic Devices of claim 18 in wireless communication with each other.

26. At least one of the at least two Portable Electronic Devices of claim 18 being capable of wirelessly communicating with a merchant payment terminal.

27. 2-Way portable electronic security devices comprising:
e. at least two portable electronic devices in predetermined 2-way electronic communication or connectivity with each other;
f. an electronic payment method authentication technology integrated into at least one of the two portable electronic devices;
g. the at least one of the at least two portable electronic devices having the integrated payment method authentication technology transmitting a response request to any portable electronic devices in predetermined 2-way electronic communication with the at least one portable electronic device when the integrated payment method is activated on the at least one portable electronic device at a merchant payment terminal; and
h. the at least one portable electronic device preventing use of the integrated payment method if no response is received from any portable electronic devices in predetermined 2-way electronic communication with the at least one portable electronic device.

28. The 2-Way portable electronic security devices of claim 27, wherein any portable electronic devices responding to a request for a response from the at least one portable electronic device must be within a predetermined distance from the at least one electronic device to provide the response.

29. The 2-Way portable electronic security devices of claim 27, wherein at least one of the two portable electronic devices is a portable phone.

30. The 2-Way portable electronic security devices of claim 27, wherein at least one of the two portable electronic devices is a smart phone.

31. The 2-Way portable electronic security devices of claim 27, wherein at least one of the two portable electronic devices is a wearable electronic device.

32. The 2-Way portable electronic security devices of claim 27, wherein at least one of the two portable electronic devices is a credit card.

33. The 2-Way portable electronic security devices of claim 27, wherein 2-way electronic communication between the at least two portable electronic devices comprises one or more of Bluetooth® communication, Wi-Fi, light communication or near field communication.

34. The 2-Way portable electronic security devices of claim 27, wherein communication method between the least one portable electronic device and the merchant payment terminal to activate the integrated payment method comprises one or more of Bluetooth® communication, Wi-Fi, light communication or near field communication, magnetic swipe or magnetic coupling.

35. The 2-Way portable electronic security devices of claim 27, wherein the at least two portable electronic devices sense and respond to the distance between each other.

36. The 2-Way portable electronic security devices of claim 35, wherein the at least one electronic device may at least temporarily disable the integrated payment method if any portable electronic devices in predetermined 2-way electronic communication with the at least one portable electronic device are outside a predetermined range.

37. The 2-Way portable electronic security devices of claim 35, wherein at least one of the two portable electronic devices produces any alert that the at least two portable electronic devices have exceeded a predetermined range from each other.

38. The 2-Way portable electronic security devices of claim 37, wherein the alert is one or more of an audio alert, a visual alert, or a vibratory alert.

39. The 2-Way portable electronic security devices of claim 37, wherein the alert is provided to the integrated payment method facilitator to place a temporary or permanent hold on the integrated payment method and any accounts associated therewith.

40. The 2-Way portable electronic security devices of claim 27, wherein the required response from any portable electronic devices in predetermined 2-way electronic communication with the at least one portable electronic device may be temporarily disabled.

41. The 2-Way portable electronic security devices of claim 27, wherein a software application is embedded into at least one of the at least two portable electronic devices.

42. The 2-Way portable electronic security devices 27 in wireless communication with each other.

43. The 2-Way portable electronic security devices of claim 27 being capable of wirelessly communicating with a merchant payment terminal.
